(19) United States
(12) Patent Application Publication
(10) Pub. No.: US 2011/0276502 A1
(43) Pub. Date: Nov. 10, 2011

(54) CENTRALIZED AND COMPUTERIZED CONTROL SYSTEM FOR CHECKING THE AUTHENTICITY OF A PRODUCT

(75) Inventor: Alfeo Dameri, Novara (IT)

(73) Assignee: DACOM S.p.A.

(21) Appl. No.: 12/775,393

(22) Filed: May 6, 2010

(51) Int. Cl. G06Q 99/00

(52) U.S. Cl. 705/317

(57) ABSTRACT

A computerized system for verifying the authenticity of products, to each product being associated a respective univocal sign, the system is provided with: a computing apparatus, which wirelessly receives and transmits data from/to a consumer terminal; and a centralized database, operatively coupled to the computing apparatus, and including a plurality of data records, each data record being associated to a particular product and the related univocal sign and having a data structure including a first field for storing a description of the product and a second field for storing the related univocal sign. The computing apparatus is able to: receive from the consumer terminal a authenticity verification request for verifying the authenticity of a given product, the request including data relating to at least part of the univocal sign associated to the given product; perform a search in the centralized database based on the received electronic data, for retrieving from the centralized database the data record associated to the given product; perform a data comparison based on the received electronic data and the univocal sign stored in the retrieved data record; determine a current result of the authenticity verification based on the outcome of the data comparison and also based on a preset verification strategy involving parameters relating to past authenticity verifications carried out at the computerized system for the same given product and/or parameters relating to characteristics of the given product; and send a response to the remote terminal including the determined current result of the authenticity verification.

### BACKGROUND

1. Technical Field

The present disclosure relates to a centralized and computerized control system for checking the authenticity of a product.

In particular, with the generic term “product” reference will be made herein to all goods that are transferred, for any reason, from a manufacturer to a consumer (or between consumers), goods of any nature and type, whether handmade or produced with industrial processes, consumer products or unique products, such as, for example, works of art. Moreover, the expression “authenticity check” will be used herein with a broad and generic connotation, to refer not only to the operation of checking the originality of a product, but also to the operation of identifying theft and third-party exchanges and, in general, the movement history of a product, which is identifiable on an individual basis.

2. Description of the Related Art

As is known, the increasingly globalized exchange of goods and the spreading of purchases via the Internet have increased the falsification and counterfeiting of products to a great extent in the last few years. In particular, counterfeiting now not only applies to branded or premium products, but also to pharmaceutical products, food and electric appliances, thus creating serious and sometimes irreparable damages not only to the customer's good faith but also to the customer's health.

Recent surveys have shown that the selling quote of counterfeit products in the global market has now reached a value of 10%, thus generating considerable losses to the producers, confusion in the market and serious damages to the final consumers.

Although some anti-counterfeiting systems have already been proposed, for example envisaging the use of RFID tags, holograms or labels with identification signs associated to the products in order to allow their identification, these systems have not proven to be fully satisfactory and reliable, and have been more or less easily bypassed and avoided by counterfeiters.

Therefore, there is a widespread need, especially for the manufacturers and the customers, well informed and attentive to the health or genuineness of the purchased goods, for a system that will allow an easy and reliable check of the authenticity of the products, which can be found in the market.

### BRIEF SUMMARY

One embodiment of the present disclosure provides a centralized and computerized control system for checking the authenticity of a product, which enables the above drawbacks to be overcome and the above need to be satisfied.

According to the present disclosure, a computerized system is provided for verifying the authenticity of products, to each product being associated a respective univocal sign, the system comprising: a computing apparatus, configured to wirelessly receive and transmit data from/to a remote terminal; and a centralized database operatively coupled to the computing apparatus, and including a plurality of data records, each data record being associated to a particular product and the related univocal sign, and having a data structure including at least a first field for storing a description of the product and a second field for storing the related univocal sign, wherein the computing apparatus is configured to: receive from the remote terminal a authenticity verification request for verifying the authenticity of a given product, the request including electronic data relating to at least part of the univocal sign associated to the given product; perform a search in the centralized database based on the received electronic data, for retrieving from the centralized database the data record associated to the given product; perform a data comparison based on the received electronic data and the univocal sign stored in the retrieved data record; determine a current result of the authenticity verification based on the outcome of the data comparison and also based on a preset verification strategy involving parameters relating to past authenticity verifications carried out at the computerized system for the same given product and/or parameters relating to characteristics of the given product; and send a response to the remote terminal including the determined current result of the authenticity verification.

### BRIEF DESCRIPTION OF THE SEVERAL VIEWS OF THE DRAWINGS

For a better understanding of the present disclosure, preferred embodiments thereof are now described, purely by way of non-limiting example and with reference to the annexed drawings, wherein:

FIG. 1 is a schematic block diagram of a centralized and computerized control system for checking the authenticity of a product, according to one embodiment of the present disclosure;

FIG. 2 shows an exemplary record of a data structure implemented in a centralized database of the control system of FIG. 1;

FIG. 3 shows an exemplary univocal sign applied to a product to be monitored in the control system of FIG. 1;

FIG. 4 shows an exemplary network hardware arrangement of a portion of the control system of FIG. 1;

FIGS. 5a-5c show flowcharts related to operations carried out by a first processing module of a computing core of the control system of FIG. 1; and

FIGS. 6a-6c show flowcharts related to operations carried out by a second processing module of a computing core of the control system of FIG. 1.

### DETAILED DESCRIPTION

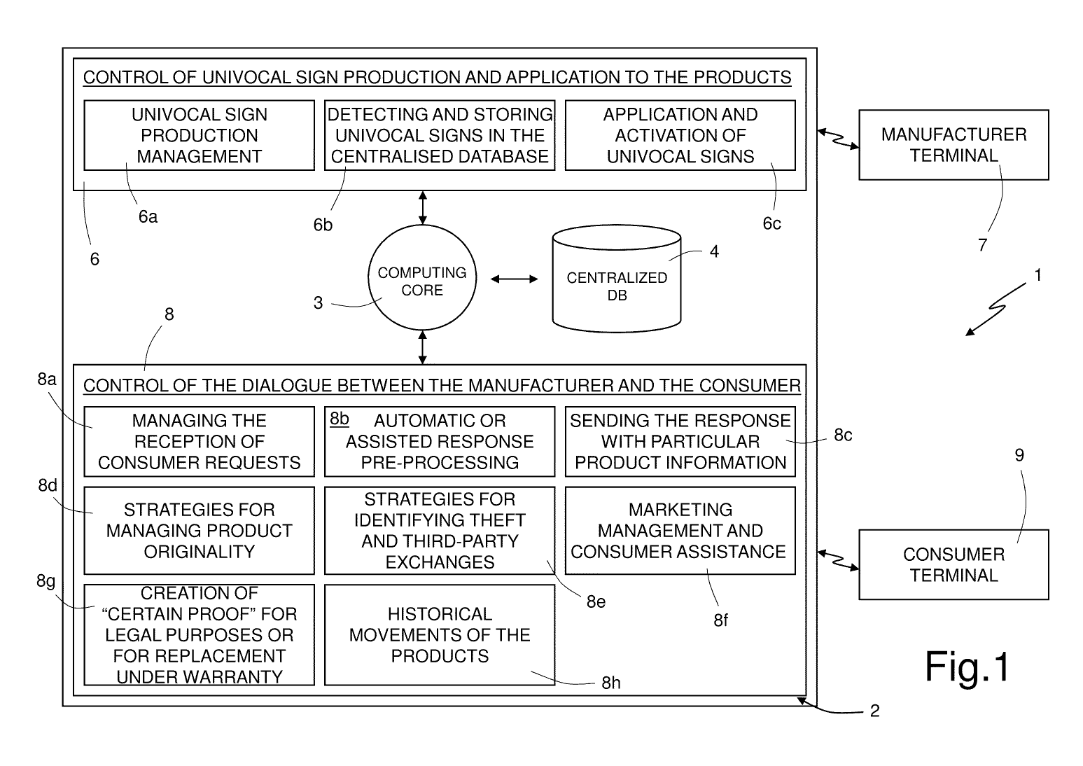

A centralized and computerized control system for checking the authenticity of a product according to one embodiment of the present disclosure is diagrammatically shown in FIG. 1, where it is denoted as a whole with reference number 1.

Control system 1 comprises a central processing apparatus 2, including a computing core 3, having data processing capability and able to wirelessly transmit and receive data, and including for this purpose Tx/Rx wireless interfaces of any known type (not shown in detail in FIG. 1). Central processing apparatus 2 is a remote apparatus, which is accessible to consumer terminals through a wireless connection of any known type. As it will be discussed in detail hereinafter, the computing core 3 in the central processing apparatus 2 includes suitable hardware and is adapted to run suitable software modules and routines in order to carry out a check of the authenticity of a product.

Control system 1 further comprises a centralized data base (DB) 4, operatively coupled to the computing core 3 in the central processing apparatus 2. Centralized database 4 includes a plurality of records, organized according to a suitable data structure; each record is associated to a particular product, whose authenticity is to be checked by the control system 1.

An exemplary data record 5 of centralized database 4 is schematically shown in FIG. 2, related to a particular product (the significance and function of each field of the data record 5 will be explained in detail hereinafter). Data record 5 includes: a first field 5a containing a description of the associated product; a second field 5b containing the univocal sign associated to the same product, and in particular a digital/numeric representation of the same univocal sign and also an analogical image thereof; a third field 5c containing data of the manufacturer of the product (and, in case, of other parties involved in the creation and application of the univocal sign to the product); a fourth field 5d containing an active status associated to the univocal sign; a fifth field 5e containing a list of verification requests associated to the product, and the related relevant data; a sixth field 5f containing a stolen status of the associated product; a seventh field 5g containing a warranty activation date for the same product; and an eighth field 5h containing a list of transfers of ownership related to the particular product.

As it will be discussed in more details hereinafter, central processing apparatus 2 schematically includes first and second processing units 6, 8. As it will be readily apparent to a person skilled in the art, each of the first and second processing units 6, 8 includes hardware and/or software elements configured to perform the required functions; in particular, both the first and second processing units 6, 8 may be implemented by the computing core 3 (e.g. running special adapted computer program products and dedicated software instructions stored on machine readable media).

The first processing unit 6 is dedicated to the control of univocal sign production and application to the products, whose authenticity will be checked by the control system 1, and includes for this purpose: a first module 6a, for univocal sign production management; a second module 6b, for detecting univocal signs and storing the univocal signs in the centralized database 4; and a third module 6c, for application and activation of the univocal signs.

As shown in FIG. 1, the first processing unit 6 implements an exchange of data (through any given wireless communication link) with a manufacturer terminal 7 (e.g., a processing device at a manufacturer plant); as previously indicated, the central processing apparatus 2 is located at a remote location from the manufacturer terminal 7.

In general terms, management of the production and application of the univocal signs on the products and their storage in the centralized database 4 are preliminary steps to the dialogue between the manufacturer, who applies the univocal signs on the respective products, and the consumer, who is interested in verifying authenticity of the same products; these preliminary steps are managed autonomously and in a centralized and automated manner by the control system 1.

The second processing unit 8 is dedicated to the control of the dialogue between the manufacturer and the consumer, and includes for this purpose: a respective first module 8a, for managing the reception of consumer requests; a second module 8b, for automatic or assisted response pre-processing; a third module 8c, for sending the responses to the consumer with particular product information; a fourth module 8d, for implementing suitable strategies for managing product originality; a fifth module 8e, for implementing suitable strategies for identifying theft and third-party exchanges; a sixth module 8f, for implementing operations of marketing management and consumer assistance; a seventh module 8g, for implementing operations related to the creation of a “Certain Proof” for legal purposes or for replacement under warranty; and an eighth module 8h, for controlling historical movements of the products.

As shown in FIG. 1, the second processing unit 8 implements an exchange of data (through any given wireless communication link) with a consumer terminal 9 (e.g. a mobile phone, a personal computer, a palmtop, or other computing device of the consumer).

In general terms, opening of a secure dialogue between the manufacturer and the consumer allows to carry out not only a verification of the originality of a product (the identification of counterfeiting products following a negative outcome of this originality verification), but also other activities, such as: identification of products subject to theft; identification of products placed on a certain market that then re-enter in another market (so called “third party exchange”); marketing with a one-to-one dialogue between the manufacturer and the consumer; activation of product warranty; consumer assistance with exchange of product information; production of the so-called “Certain Proof” for legal purposes of the actual counterfeiting of a product or for replacing of a product under warranty; creation of a history of movements of individual products.

In particular, each product managed by the control system 1 is identified individually with a unique sign that is inserted, applied or integrated within the same product at the manufacturing stage. The process of creating and assigning the respective univocal sign to each product, controlled by the first processing unit 6, is completely automatic and guaranteed by security mechanisms that verify the objects and procedures involved in the physical creation of the univocal sign.

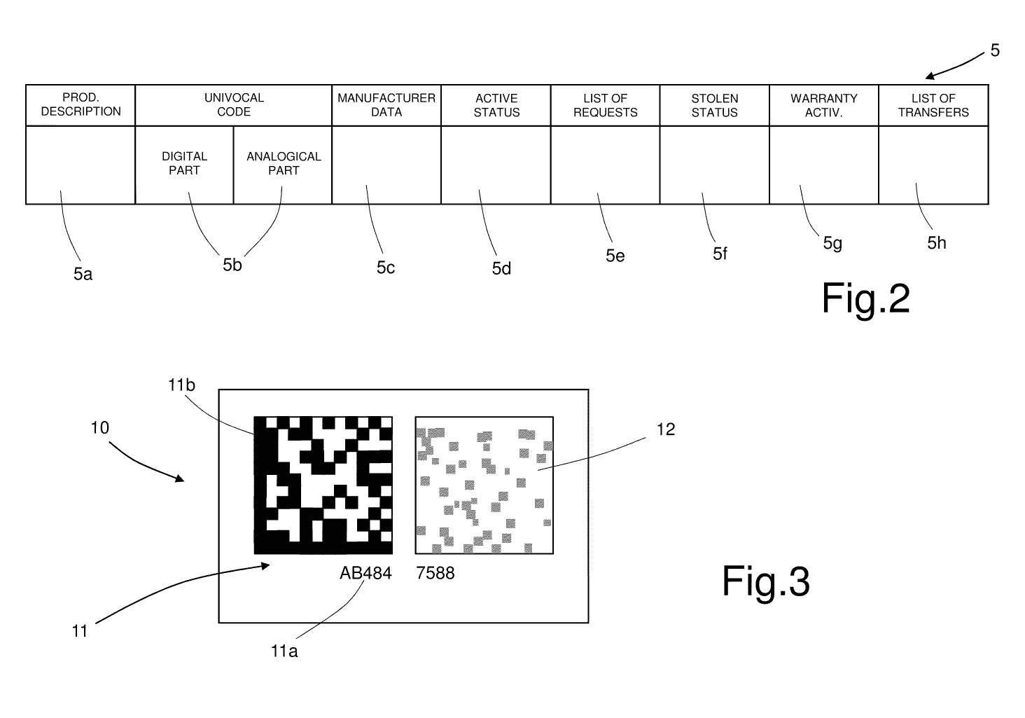

According to one embodiment of the present disclosure, as exemplary shown in FIG. 3, the univocal sign 10 that individually identifies each product includes two parts: a digital (or numeric) part 11; and an analogical (or image) part 12. The univocal sign 10 may be applied directly on a product, or instead it may be applied on a label to be applied to the product.

The digital part 11 of the univocal sign 10 is represented as a plain text alphanumeric code 11a and/or a graphical code 11b (such as any currently, or in the future, available kind of one, two-, or three-dimensional codes, such as bar codes); in particular, the alphanumeric code 11a is adapted for non-automatic reading, e.g. by a human operator, while the graphical code 11b is suited for automatic reading by an automated apparatus (such as a bar code reader). In any case, the digital part 11 of the univocal sign 10 includes a serial number, which identifies the manufacturer and the product, and a random security number (generated with any known technique), which makes it impossible to know the whole digital code a priori; both the serial number and the random security number are represented in the alphanumeric code 11a and/or graphical code 11b, according to given distribution criteria (as a non limiting example, the whole serial number may be represented in the alphanumeric code 11a, while the random security number may be represented in part in the alphanumeric code 11a and in part in the graphical code 11b, if present; clearly, other kind of distribution criteria may equally be envisaged).

The analogical part 12 of the univocal sign is generated with any known or future available technique, which is able to create an irreproducible analogical image using random methods for insertion, application or printing of non a reproducible sign. For example, the analogical part 12 of the univocal sign is generated via a serigraphic, flexographic or offset printing process; through the spreading of microparticles (or submicron particles) of any suitable material; via the creation of a random pattern of bubbles; or through the creation of colored areas (or areas with different tones, shadings, hues) having a random pattern. As a non limiting example, the analogical part 12 may consist of a label, to which several raised dots are applied based on a random, and therefore non duplicable, distribution pattern; these dots are realized with different printing inks, and then may be coated with a transparent film that shows only a given number of them, thus making the sign indeed “univocal”.

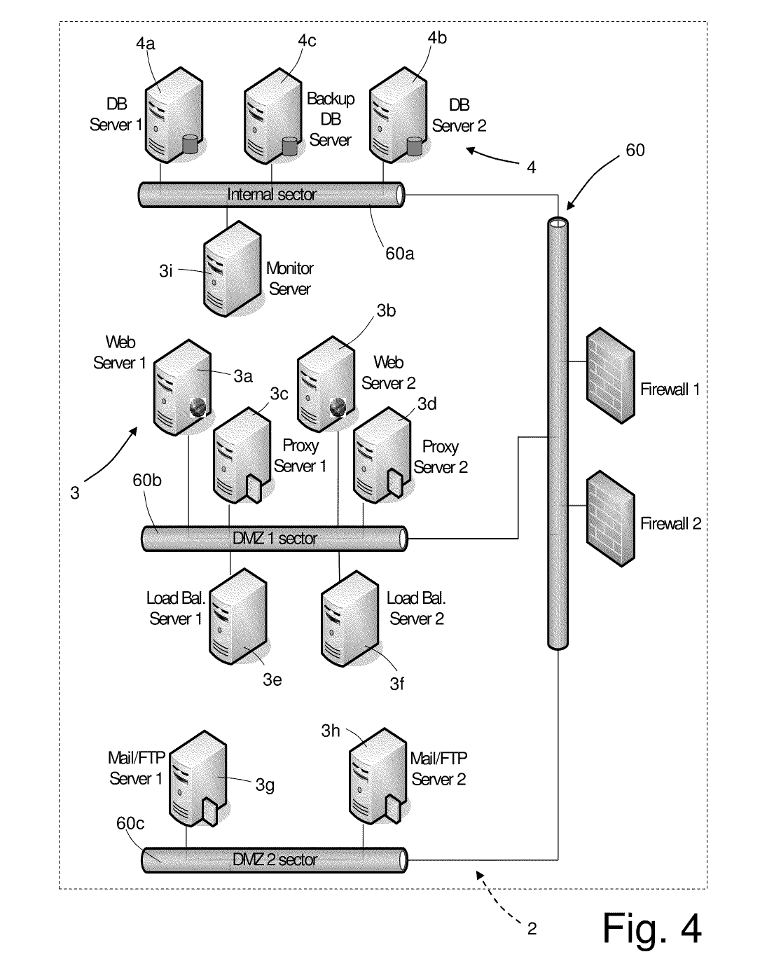

In an exemplary embodiment, as shown in FIG. 4, the computing core 3 and centralized database 4 of the central processing apparatus 2 are implemented through a common server farm, i.e. a cluster, or collection, of computer servers (of any currently, or in the future available, type), connected through a data network 60.

In particular, the data network 60 includes an internal network sector 60a, which is isolated from the outside world (i.e. the interne network) by a suitable firewall arrangement, and to which the centralized database 4 is connected; in this embodiment, the centralized database 4 is implemented via a first and a second SQL database server 4a, 4b (each including, for example, four SCSI hard disks with a capacity of 72 GB), storing in a shared and balanced manner the various data records 5, and a backup database server 4c, operating as a backup for the SQL database servers 4a, 4b, in the event of malfunctions thereof; in this exemplary embodiment, the centralized database 4 is thus distributed among various servers in the server farm.

The data network 60 also includes a first and a second DMZ network sectors 60b, 60c, interfacing with the outside network (again, with the interposition of a suitable firewall arrangement) and separated at the VLAN level. In this embodiment, the computing core 3 of the central processing apparatus 2 includes a first and second Web server 3a, 3b (each including, for example, two SCSI hard disks with a capacity of 72 GB, a dual-processor mother board with XEON processor operating at 3.6 GHz, and 4 GB of RAM), managing, with a balanced processing load, the various requests coming from the users of the control system 1 (and in particular implementing, at least in part, the first and second processing units 6, 8); in this embodiment, the computing core 3 is thus distributed among various servers in the server farm.

The first and second Web server 3a, 3b are coupled to the first DMZ network sector 60b through a respective LINUX server 3c, 3d, with REVERSE PROXY and SSL cryptography functions, and in particular for processing the requests addressed to the respective Web server 3a, 3b and filtering out those that do not satisfy given security requirements; servers 3c, 3d also operate as PROXY servers towards the clients as far as static contents are concerned (images, background pictures, etc.), so that requests concerning these contents are satisfied without any burden to the Web servers 3a, 3b.

A first further couple of LINUX servers 3e, 3f is coupled to the first DMZ network sector 60b, operating as load balancer towards the first and second Web servers 3a, 3b; while a second further couple of LINUX servers 3g, 3h (both in High Availability configuration) is coupled to the second DMZ network sector 60c, for managing MAIL and FTP operations, towards the outside clients.

In the disclosed arrangement, processing power can be easily increased, adding further couples of WEB servers and corresponding PROXY servers (which are associated in a one-to-one configuration with the respective WEB servers); in that case, the load balancer servers will operate to route the incoming requests to the various Web application servers.

In the embodiment depicted in FIG. 4, the computing core 3 of the central processing apparatus 2 further includes a network monitoring server 3i, coupled to the internal network sector 60a of the data network 60 for monitoring the overall performance of the same network; in particular, the network monitoring server 3i performs continuous tests on the network servers and apparatuses, so as to timely identify any malfunction, and activate backup and recovery units, in case problems are identified. In a way not shown, all the main components of the server farm are indeed conveniently duplicated in a recovery web farm, as a fail safe arrangement.

The operations performed by the first processing unit 6 for controlling the univocal sign production and application to the products will now be disclosed in more details.

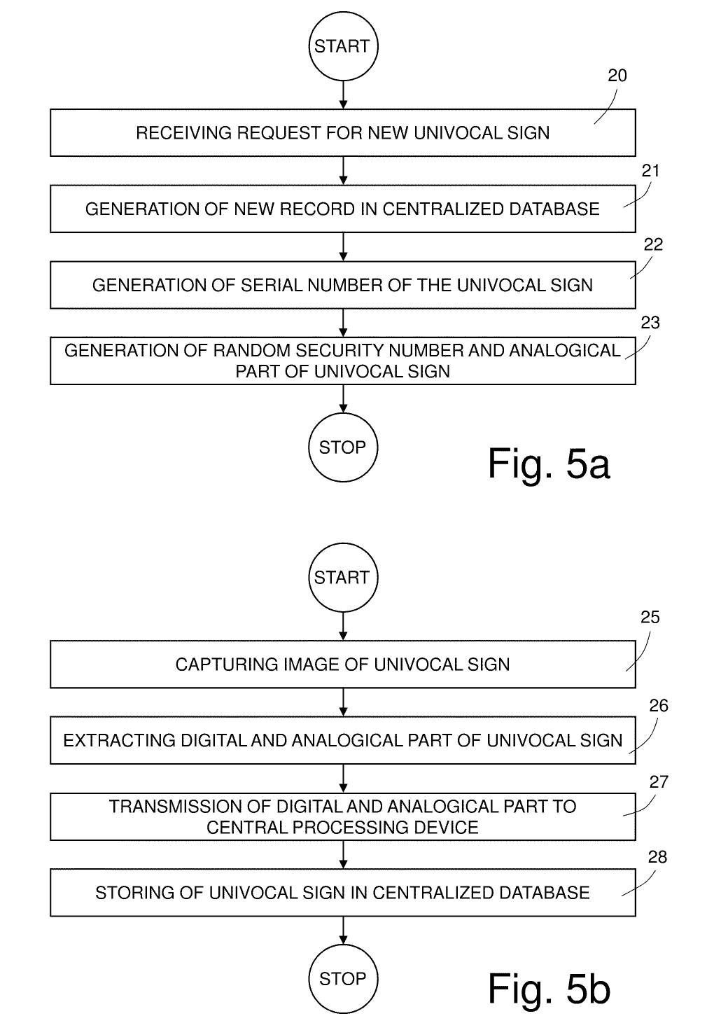

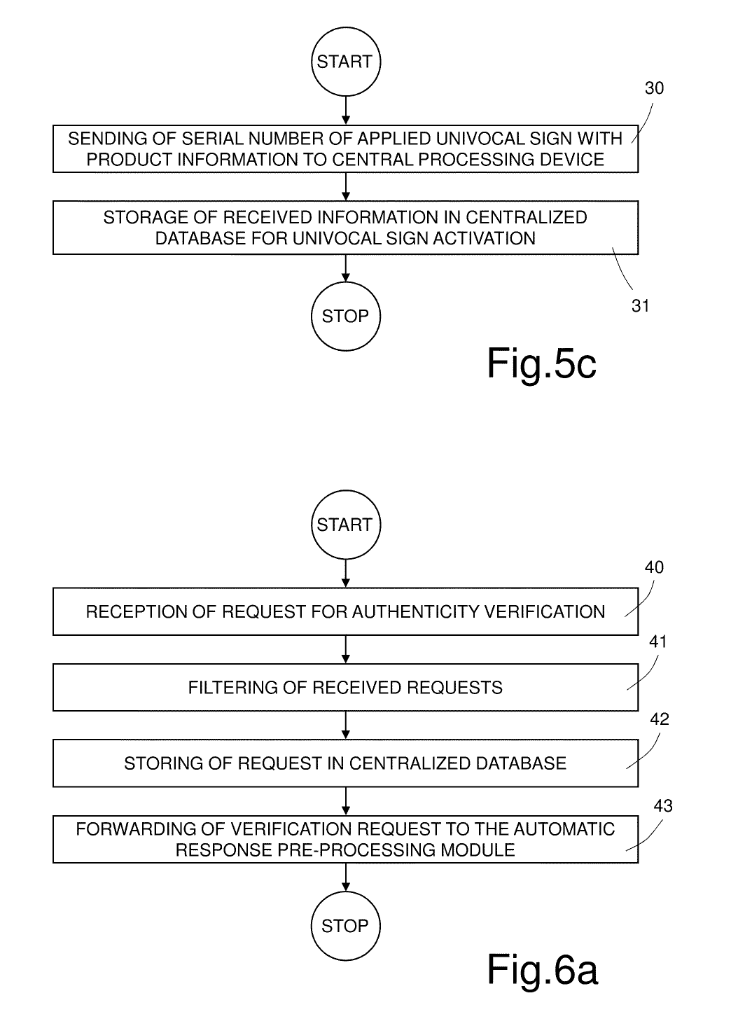

As shown in FIG. 5a, operations performed by the first module 6a for univocal sign production management first envisage, at step 20, the reception at the central processing apparatus 2 of a request from manufacturer terminal 7 to obtain a new univocal sign 10 to be associated to a new product; as previously explained, this request is transmitted through a wireless link (e.g. an internet communication link), through a suitable exchange of data and information. It is to be noted that the following description will refer, for sake of simplicity, to a request concerning a single product, but it is clear that the request may conveniently relate to a whole lot or batch of products, for receiving a corresponding number of different univocal signs.

In response to the received request, at step 21, the first module 6a at the central processing apparatus 2 controls generation of a new data record 5 in centralized database 4, and storing in the third field 5c of the same data record 5 (that is going to be associated to the new product) of relevant data concerning the manufacturer (and, in case, of other parties that will be involved in the creation and application, insertion or integration of the univocal sign to the product, such as labeler, paper manufacturer, etc.); all these data may be already available to the central processing apparatus 2 or may be received from the same manufacturer sending the request for the new univocal sign.

The same first module 6a then controls, at step 22, the generation of the serial number of the digital part 11 of the new univocal sign 10, which identifies the manufacturer and the product, and sending thereof to the manufacturer terminal 7, through the established communication link.

Next, as shown in step 23, the random security number of the digital part 11 of the univocal sign 10 is generated at the manufacturer terminal 7, with any technique suitable for generation of random security codes. The analogical part 12 of the univocal sign 10 is then also generated with any suitable technique, at the manufacturer plant or at a supplier plant, as previously discussed.

As shown in FIG. 5b, operations performed for detecting and then storing univocal signs in the centralized database 4, envisage, at step 25, capturing, at the manufacturer (or supplier) plant by suitable imaging devices, such as high definition cameras, an image of the univocal sign 10 that has been generated; in particular, the image is taken such as to allow identification of both the digital part 11 and the analogical part 12 of the univocal sign 10.

Next, at step 26, the captured image is processed (e.g. at the manufacturer terminal 7), so as to extract and detect the digital part 11 of the univocal sign 10 (including both the serial number and the random security number), and the analogical part 12 of the same univocal sign 10. In particular, during the image capturing and processing steps, quality checks are continuously performed, so as to ensure that all detected signs meet predefined minimum required quality specifications; signs that are judged to be non-compliant to these minimum specifications are discarded.

Afterwards, at step 27, the complete digital part 11 of the univocal sign 10, and the detected image of the related analogical part 12, are sent to the central processing apparatus 2 and received at the second module 6b of the first processing unit 6. The transmittal operations are made secure through the use of known safety mechanisms, e.g. based on asymmetric cryptography and public and private keys; confidentiality of the sent and received information is thus assured.

Next, at step 28, the second module 6b controls storing in the second field 5b of the data record 5 of the centralized database 4, which has been previously assigned to the new univocal sign, of both the complete digital part 11 (including both the serial and random security numbers) and the analogical part 12 of the same univocal sign 10. In particular, the storing date is certified and digital signature techniques, of any known type, are applied during storing of these data in the centralized database 4.

As shown in FIG. 5c, operations performed for application and activation of the univocal sign on a particular product envisage, at step 30, that, after the generated univocal sign 10 has been actually inserted, integrated or applied to the product, the manufacturer sends the serial number of the univocal sign 10 that has been applied to the product to the central processing apparatus 2, together with the information that the same univocal sign is active (i.e. it has been applied to a product), and also together with information describing the product to which the sign has been applied.

In particular, this information, which is transmitted from the manufacturer terminal 7 to the central processing apparatus 2, may also include unique details about products, such as works of art or original works; otherwise, this information may relate to a category of products and include a product registry code. The product information is sent by the manufacturer to the central processing apparatus 2 in all languages that the manufacturer will then use to respond to the consumer requests (as will be detailed hereinafter).

Next, at step 31, the third module 6c controls the reception from the manufacturer terminal 7 of the serial number of the univocal sign 10, accompanied by the information describing the product, and then the storage in the first field 5a of the data record 5 of the centralized database 4, which has been associated to the univocal sign 10, of the information describing the product to which the sign has been applied.

These operations, as a whole, activate the product's univocal sign 10, which was not before associated with any active product, and in particular implement the electronic irremovability of the univocal sign associated with the product (electronic irremovability meaning that the particular description of the product associated with the univocal sign 10 assures that the same univocal sign 10 cannot be applied to a product other than the originally intended one). In particular, a positive active status of the univocal sign 10 is stored in the fourth field 5d of the data record 5 associated to the product in the centralized database 4.

The manufacturer is able to remotely access and query the centralized database 4 of the control system 1 at any moment, with suitable graphical user interfaces and with automatic processing tools, in order to have real-time information about the status of all univocal signs 10 associated with its products. In particular, these checks allow the manufacturer to activate the following functions: reading/verification of all assigned and produced univocal signs still to be applied to products (so called “INACTIVE univocal signs”); and reading/verification of all produced univocal signs 10 that were already applied to products (so called “ACTIVE univocal signs”). By searching through the inactive univocal signs and the active univocal signs applied on products that were already distributed, the manufacturer is thus able to discover any parallel production of univocal signs/products.

Based on the above discussion, it is apparent that the operations performed by the first processing unit 6 of the central processing apparatus 2 for controlling the univocal sign production and application to the products provide a number of advantageous technical effects, that will be now briefly summarized.

A digital code, which is unique world-wide, is created automatically for each product, and is used to securely identify the product on a global level (forming the digital part 11 of the univocal sign 10); it is associated with the analogical part 12 to create the univocal sign 10, thus ensuring its irreproducibility.

During the process of creating the univocal sign 10, automatic quality control operations are performed; the created sign has to comply with minimum specifications, otherwise it is discarded.

The univocal sign 10 is detected during production and automatically separated into the digital part 11, which has an alphanumeric code and/or a graphic form, such as a one or two-dimensional bar code, and into the analogical part 12 that is detected as a high resolution image.

The univocal sign 10 is stored in the centralized database 4 on a world-wide level using both the alphanumeric code and the high resolution image of the analogical part 12; the storage of this image, as disclosed hereinafter, will allow implementation of several automatic algorithms for image recognition and comparison.

The product's alphanumeric digital code consists of a sequential serial number that identifies the manufacturer and the product, and of a random part that makes it impossible to know a priori the composition of the codes contained in the centralized database 4, and therefore represents the random security number of the alphanumeric digital code. This security number and the analogical part 12 of the univocal sign 10 can be covered during the production phase to prevent them from being examined before the product is transferred to the consumer, preventing any unauthorized use of the sign.

Each univocal sign 10 is stored in the world-wide unique centralized database 4 with a production status associated inseparably thereto, and indicating that the same univocal sign has not yet been applied to the product (INACTIVE status), or else that it has already been inserted, integrated or applied to the product (ACTIVE status).

Each ACTIVE univocal sign 10 is inseparably associated to the particular product information that has been provided by the manufacturer during the univocal sign activation phase, in various languages, in the form of a registry code and/or textual and/or alphanumeric description as well as in the form of product images. The particular information can be stored for a category of products, or for each individual product, with the possibility therefore to manage data such as the particular identification number of each product or unique information about products such as works of art or original works.

The univocal sign 10 associated to the product can only be activated by the manufacturer after supplying the particular product information. The activation of the univocal sign 10 applied on the product guarantees the univocal sign/product association and does not leave room for counterfeiting items during production.

In particular, the univocal sign 10 is activated by transmitting only the serial number of the univocal sign's digital part 11 (without the security number); this makes it possible to cover the univocal sign's security code before activating the product's univocal sign.

The association between the univocal sign 10 and the particular product information, which are stored in the centralized database 4, assures the electronic irremovability of the same univocal sign 10 from the product, guaranteeing that the univocal sign 10 cannot be applied on a product that is different than the original one.

Particular product information can also be inserted in the one or two dimensional bar code of the digital part 11 of the univocal sign 10.

The manufacturer is able to query the centralized database 4 in real time, with user interfaces or automatic systems to receive information about all univocal signs connected to the manufacturer's products. In this way, the manufacturer can be informed in real time about the situation of the univocal signs managed by the control system 1 and is able to discover any parallel production.

All data transmission and the operations for storing the information about the univocal signs and associated products in the centralized database 4 are guaranteed by security mechanisms, e.g. based on public and private key cryptographic techniques, or guaranteeing the certainty of the identification of the person entering the information. Also, each univocal sign 10 is associated automatically and inseparably with a certain storage date with the use of digital signature techniques.

The insertion or subsequent search for a univocal sign 10 in the centralized database 4 may be done using the digital part 11 of the same univocal sign, which guarantees the immediate and secure retrieval of the univocal sign 10, without the need to apply complex and approximate search algorithms related to the analogical part 12 (and involving image processing).

The operations performed by the second processing unit 8 for controlling the dialogue between the manufacturer and the consumer will now be disclosed in more details; these operations allow the creation of a direct channel of communication between the manufacturer and the consumer, with tools providing real-time responses in order to verify product authenticity.

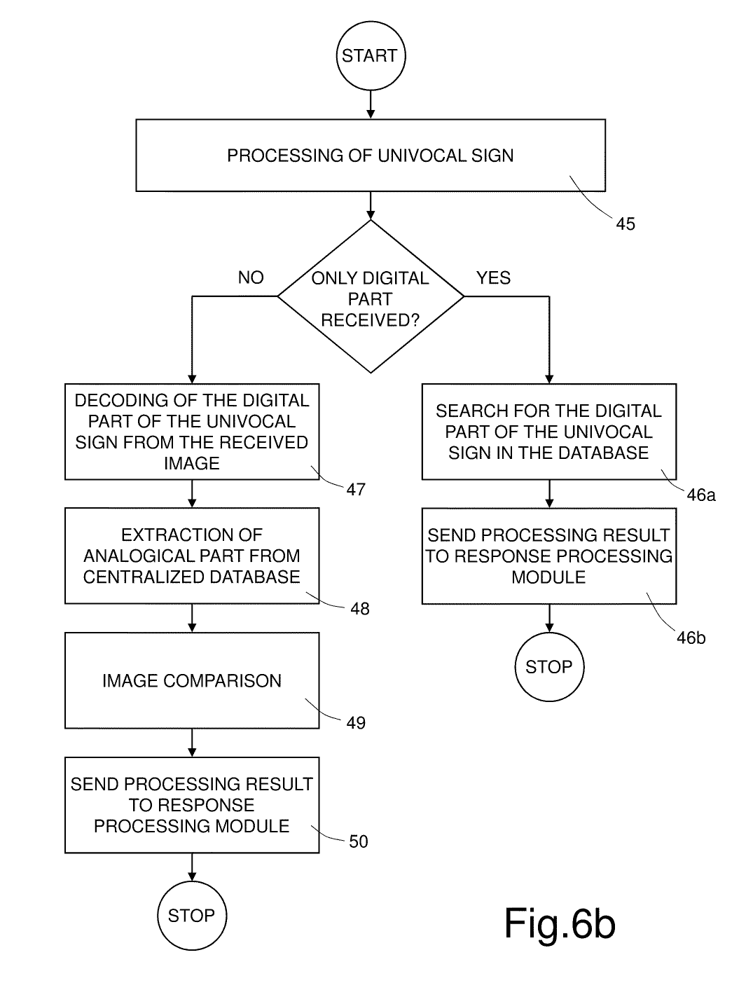

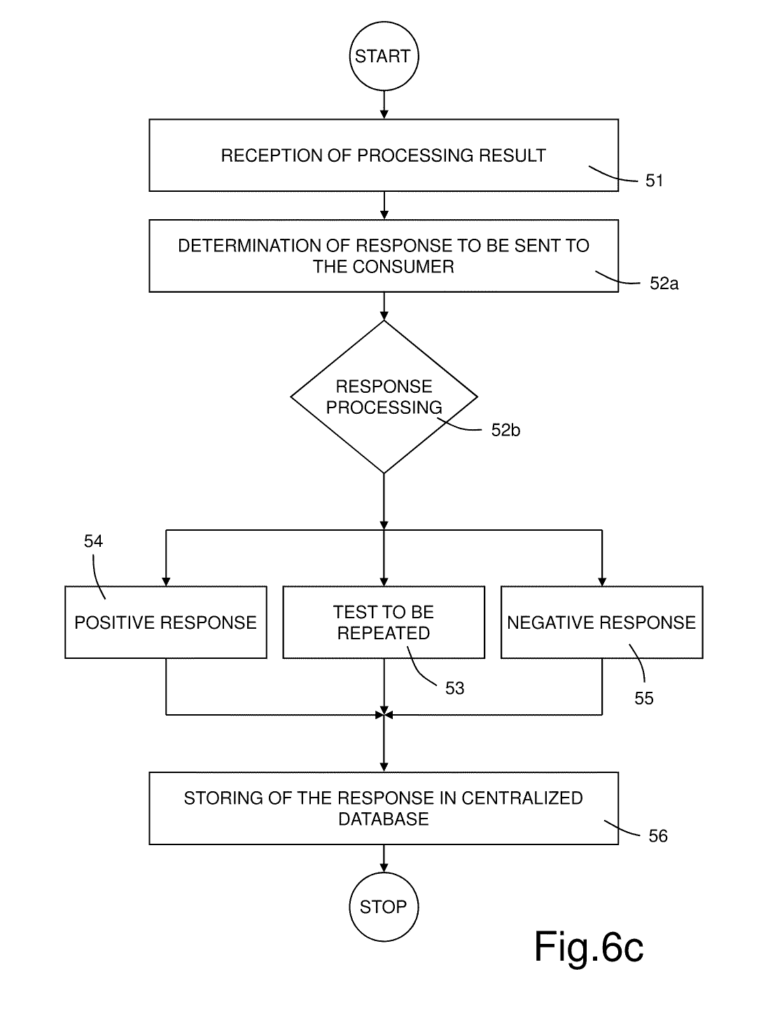

As shown in FIG. 6a, operations performed by the first module 8a for managing the reception of consumer requests envisage, at step 40, the automatic reception at the central processing apparatus 2 of a request for verification of a product authenticity from a consumer terminal 9; the request is transmitted through a data communication link established between the consumer terminal 9 and the central processing apparatus 2.

Data can be sent by the consumer through any known current or future method able to send images or alphanumeric codes; for example, data can be sent: from a mobile phone, via MMS, e-mail, e-mail push/pull, chat, www, web services, rpc, ftp, http, tcp/ip, ppp; from a computer, via e-mail, chat, www, web services, rpc, ftp, http, tcp/ip, ppp; from a digital camera, via MMS, e-mail, e-mail push/pull, chat, www, web services, rpc, ftp, http, tcp/ip, ppp; from a traditional phone using voice or keypad functions (as far as the alphanumeric code is concerned); via fax or even letter. It is to be noted that, as is known in the art, secure communication protocols (https or ftps, etc.) may be activated on some of those means of communications, such as the internet from mobile phones or personal computers, in order to guarantee that the information sent from and to the consumers is not read by unauthorized parties.

In particular, the following data are associated to each request: a first identifier related to the means of communication with which the request has been sent, and a second identifier related to the means of communication to which the response has to be sent (these means of communication may coincide in some cases). These identifiers may thus include: e-mail address; IP address; landline or mobile phone number; mobile phone IMIE number; fax number; postal address; or any other identifier for identifying the sender or receiver according to any current or future communication technique.

In any case, the control system 1 envisages the use of unique world wide references for each communication method (i.e. a unique telephone number, internet address and web site, e-mail address, postal address, etc.), so as to avoid the possibility that any system parallel to the control system 1 may be contacted and send a false authenticity verification result to the consumer.

In particular, step 40 envisages reception of either the sole digital part 11 of the univocal sign 10 associated to the product, or reception of the complete univocal sign 10 (complete with the analogical part 12); the amount of information provided by the consumer depends, in fact, on the technical means available, which may allow to take a picture of the univocal sign or to detect only the digital part thereof.

Next, the first module 8a of the second processing module 8 controls activation of automatic mechanisms for checking and filtering of the received request, at step 41, in order to detect verification requests that have the sole purpose of invalidating the control strategies, which will be better described in the following paragraphs.

In particular, the received verification requests are compared with those on the following three lists (which are stored and kept up-to-date by the central processing apparatus 2 in a suitable portion of the centralized database 4):
a “black list” for multiple unauthorized verification requests: multiple requests arriving from a same sending source, or to be directed to a same receiver, are stored on this list (automatically or by operator-assisted operations), in order to be blocked and not to be sent for further processing;
a “white list” for multiple authorized verification requests: multiple requests arriving from known sending sources such as inspection agencies, individual inspectors from third party agencies, or manufacturers are stored on this list, in order to be forwarded for further processing; however, as will be explained hereinafter, these verification requests, are not registered in the centralized database 4 in association with the related product and do not increase the number of verification requests related to the same product; and
a “grey list” for suspicious requests: multiple requests arriving from a same sending source or directed to a same receiver, which are not immediately recognizable as trusted or malicious, are placed on this list, so as to be verified by an operator and placed either in the black or white lists, as discussed above.

After this check, at step 42, the first module 8a controls storing of the received verification request in the centralized database 4 in association to the related product.

In particular, the following data relating to the received verification requests are stored for each product, in the fifth field 5e of the data record 5 associated to the same product:
the number of times a verification of authenticity was requested;
for each individual request, the sending and intended receiver source and method, and the related identifiers (IP address, e-mail address, landline or mobile phone number, origin, geographic area, operator and any other relevant data); and
the date and time of the received requests.

Then, at step 43, the first module 8a controls forwarding of the received verification request to the second module 8b of the second processing unit 8, for the automatic response pre-processing process.

As shown in FIG. 6b, operations performed by the second module 8b for automatic or assisted response pre-processing, envisage, at step 45, the processing of the univocal sign 10 associated with the request received from the consumer terminal 9 (processing of only the digital part 11 of the univocal sign 10 or of the whole univocal sign, according to the kind of request sent by the consumer and the available communication means available to the same consumer).

If only the digital part 11 is received, at step 46a, the second module 8b performs an automatic search in the centralized database 4 in order to search for the digital part 11 of the received code. The result of the search is sent to the third module 8c, at step 46b, which will then send the response to the consumer about the authenticity of the product (as detailed hereinafter); this processing result is in the form of a “OK” message, if the code has been found in one of the data records 5 of the centralized database 4, or a “NOT OK” message, otherwise.

If the image of the whole univocal sign 10 is instead received, the second module 8b performs a check, which conveniently takes also into account the analogical part 12 of the univocal sign 10.

In particular, at step 47, the second module 8b first performs the automatic decoding of the digital part 11 of the univocal sign 10 from the received complete image.

If the image cannot be decoded, a request will be sent to the consumer by the third module 8c to repeat the test (as discussed hereinafter). Otherwise, the second module 8b, at step 48, performs an automatic search for the decoded code in the centralized database 4, and then extracts the associated image of the analogical part 12 of the univocal sign 10 (as stored in the same data record 5).

The second module 8b then performs, at step 49, a comparison of the image extracted from the centralized database 4 with the image of the univocal sign 10 received from the consumer. The result of this comparison takes image quality into account: if the image quality is poor, it will be requested to repeat the test; if the image quality is good, a comparison result is automatically calculated, being expressed in terms of a similarity index ranging between 0 and 100 (where 0 refers to completely different images and 100 refers to substantially identical images); if image quality is mediocre, the images may be sent to an operator, who will view the two images, with the help of visual comparison tools (such as enlargement, measurements, verification of individual points) and manually indicate the result of the comparison.

In particular, in the case in which the images are compared automatically, the following cases may occur: if the similarity index is lower than a preset minimum value, configurable between 0 and 100, the result of the automatic comparison is judged to be negative; if the similarity index is higher than a maximum value, higher than the minimum value and also configurable between 0 and 100, the result of the automatic comparison is judged to be positive; if the similarity index falls between the minimum and maximum threshold values, i.e. in the case of uncertain comparisons, an operator may again be asked to assist with the comparison, in order to determine the final result (accordingly, the operator may be requested to assist with the comparison, both for images having a mediocre quality, and for uncertain cases regarding the processing of the results).

In any case, at step 50, the second module 8b transmits the result of the automatic (or operator-assisted) image comparison to the third module 8c; this result can thus be: a “NOT OK” message, in the case in which the digital part 11 of the univocal sign 10 has not been found in the centralized database 4, or the result of the comparison is less than the minimum threshold value; a “OK” message in the case in which the digital part 11 of the univocal sign 10 has been found in the centralized database 4 and the result of the comparison is higher than the maximum threshold value; a “NC” (not calculable) message in the case in which the digital part 11 of the univocal sign 10 cannot be decoded from the received image, or the quality of the image used for the comparison is too poor.

Operations performed by the third module 8c for sending the response to the consumer with particular product information are shown in FIG. 6c, and are now discussed in detail.

At step 51, the third module 8c receives from the first and second modules 8a, 8b the result of the processing carried out for the digital part 11 and/or the analogical part 12 of the univocal sign 10, and in particular one of the following results: the source of the request has been found on the black list (as determined by the first module 8a); the comparison result is “NC”; the comparison result is “NOT OK”; the comparison result is “OK” (as determined by the second module 88).

At steps 52a, 52b, based on the received result, the third module 8c determines the response to be effectively sent to the consumer.

In particular, if the source is found on the black list, no response is sent (for the reasons discussed above).

In the case of a “NC” result, a response is sent to the consumer terminal 9, at step 53, indicating that the test must be repeated in order to achieve a reliable result about the authenticity of the product.

In the case of an “OK” result, according to an aspect of the present disclosure, further automatic processes are activated by the central processing apparatus 2, for generating the response, also taking into account preset strategies for product originality verification or for identifying theft or third-party exchanges; these strategies, which will be discussed hereinafter, are based on parameters relating to the queries previously stored in the centralized database 4 for the same product, and contribute to the formation of the correct automatic response to be sent to the consumer terminal 9. In this step, the third module 8c also cooperates with the fourth and fifth modules 8d, 8e for implementing suitable strategies for managing product originality, and for identifying theft and third-party exchanges.

If, based on this further processing, a positive response is then automatically selected, the positive response regarding product authenticity is sent to the consumer, at step 54; this positive response is accompanied by the particular product information, both in the form of a text description and of images of the product. The consumer receives the positive response and the particular product information and can therefore verify that the univocal sign was not applied to a product different than the original and intended one.

On the contrary, if a negative product authenticity response is automatically selected, the negative response regarding product authenticity is sent to the consumer terminal 9, at step 55. In particular, based on existing agreements between the consumer and the manufacturer (which are stipulated in any suitable manner), one of the following three cases may be applied:
if the agreements provided to the consumer specify that in the case of a negative response the consumer's information will be sent to the manufacturer, an automatic message is also sent to the manufacturer terminal 7 by the third module 8c, with all the data regarding the authenticity request, so as to allow the manufacturer to directly contact the consumer;
if there are no specific agreements, the consumer can be sent a request to provide his/hers consent to have his/hers data sent to the manufacturer;
data can be sent to the consumer to be used to directly contact the manufacturer.

In any case, the third module 8c controls sending of the responses to the consumer terminal 9, using the same means of communication with which the request was received, or using another address specifically indicated in the request.

Finally, in the case of a “NOT OK” result, again a negative response is sent to the consumer, at step 55, indicating that the product is not original, as previously indicated.

After sending the suitable response, the third module 8c also controls, at step 56, the storing in the centralized database 4 (in the fifth field 5e of the data record 5 associated to the product), of the following data: date and time of the responses sent to the consumer terminal 9; and the complete responses, as sent to the consumers.

As previously indicated, the automatic selection of the response is performed also based on values and parameters set in the fourth module 8d for the management of strategies for product authenticity verification and for identifying theft or third party exchanges; the third module 8c indeed cooperates at steps 52a, 52b with the fourth module 8d to determine the correct response to be sent to the consumer.

In this respect, the fourth module 8d automatically processes the authenticity requests and verifications performed for a particular product, that are stored in the centralized database 4, based on given preset parameters (which may be established by the manufacturer), and cooperates with the third module 8c in the determination of the correct response to be sent to the consumer.

As previously underlined, the following data are stored in the centralized database 4 for each product:
the number of times a verification of authenticity was requested;
sources, methods and identifiers of each individual request (IP address, mail, landline or cell phone number, origin, area, operator and other);
date and time of the request and response;
the complete sent responses;
any other parameter that may be used to create a response strategy (such as product diffusion and quantity; how the univocal sign is inserted, integrated or applied to the product; the fact that the univocal sign is covered or not, etc.).

Based on the above data and parameters, it may established (e.g. according to the needs of the manufacturer) a cost/benefit ratio strategy for identifying counterfeits and therefore the correct message to be sent to the consumer if there is a possibility, calculated based on the previous stored requests or other parameters, that the product is not original.

An operative example of a management strategy for product authenticity verification may provide that, if the product is identified with a partially covered univocal sign, it is reasonable that only the person who will first acquire the item verifies its originality by removing the cover placed over the univocal sign. In this case, after a first authenticity verification request has been answered with a positive result for a particular product, a successive further request will be answered with a negative response (since the further request will be considered to be associated to a probably counterfeit product), at least until a transfer of the same product to another consumer has been registered.

As a further example, the result of the current authenticity verification may be based on the number of past verifications already performed for the particular product; on the geographical origin of the requests; or on the means of communication used for sending the requests.

In any case, the control system 1 advantageously allows to automatically process authenticity verification requests not only based on a comparison of the received univocal sign with the corresponding sign stored in the centralized database 4, but also based on the history of the previously received requests and the previously sent responses for the same product (which are also stored in the centralized database 4); this allows to generate a response that also takes into account the need and strategies of a particular manufacturer and the nature and specificity of a product and the related univocal sign.

In a substantially analogous manner, also the fifth module 8e cooperates with the third module 8c for generation of the correct response to be sent to the consumer (again at steps 52a, 52b, as previously discussed), based on data stored in the centralized database 4; in particular, the fifth module 8e implements further checks in order to identify theft and third-party exchanges. The response to be sent to the consumer may indeed also take into account these further checks.

In particular, during the manufacturing and the subsequent commercial product distribution phases, the manufacturer is able to store information in the centralized database 4 regarding the area or market in which the product has been or will be placed. Moreover, the stolen status associated to the product in the centralized database 4 (stored in the sixth field 5f of the data record 5 associated to the same product) allows to effectively monitor any theft of the product during its lifetime. All this information allows to provide the manufacturer with indications that a product was subjected to theft or third-party exchanges.

Accordingly, each time a request for authenticity verification is made, the fifth module 8e checks the information about the source that sent the request and the information about the product status, stored in the centralized database 4. If it is verified that the product is indeed stolen or placed on a different market than the one from which the verification request originates, an automatic message is sent to the consumer and/or manufacturer. For example, as previously discussed, a negative response regarding the authenticity check may be sent to the consumer, or information may be sent to the manufacturer for directly contacting the consumer; or a request may be sent to the consumer for providing consent to have his/hers data sent to the manufacturer. In the case that involves the discovery of third party exchanges, a message can be managed that is sent to the consumer, directly requesting the market in which the product was purchased.

Suitable costs/benefits strategies may be applied by the fifth module 8e when determining and identifying theft and third-party exchanges.

As previously indicated, control system 1, through the dedicated sixth module 8f of the second processing unit 8, also controls operations aimed at marketing management and consumer assistance.

In fact, the information collected by control system 1 for authenticity verification, connected to each individual product, can be made available to the manufacturer to activate targeted one-to-one marketing campaigns or for managing post sales problems such as the activation of a product warranty or sending post sales information.

The information collected with the direct consent of the consumer (the sixth module 8f can manage obtaining of the consumer direct consent) may be made available and used directly by the manufacturer or in some cases by other specialized companies. Data collected by the control system 1 can be considered as high quality data because they are supplied by the consumer for an important reason, i.e. the authenticity verification, that indirectly involves the consumer's profitability, health and safety. For this reason, it is reasonable to believe that with the data collected by the control system 1, targeted one-to-one campaigns can have a maximum effect.

The manufacturer can use the control system 1 also to activate the legal warranties required for the individual products. The previously described rules and methods for identifying product authenticity, based on the application and management of a univocal sign, can indeed be used also to activate the warranty for each original product, after it has been bought by the consumer.

The consumer can send the code or image of the univocal sign applied on the product warranty to the control system 1. In addition to verifying the uniqueness of the warranty, the control system 1 will automatically register the request with a certain date (warranty activation request date). Subsequent requests for the same univocal sign, for warranty activation, will be easily refused as being non-original.

Advantageously, the above warranty activation request date is stored in the centralized database 4, in the seventh field 5g of the data record 5 associated to the product.

Control system 1, through the dedicated seventh module 8g, also controls operations related to the creation of a “Certain Proof” for legal purposes or for replacement of a product under warranty.

It is often the case that, due to the serial production of non-exclusive products and production technologies, in court the examination between an original product and a counterfeit product does not lead to a certain result and the judge cannot issue a final sentence because there is no “Certain Proof” distinguishing two products. If there is a real product (original) and a real false product (the counterfeit product), these products are identical because often they originate from the same third-party chain (or its workers) used by the manufacturer. The same occurs when there is a defective product that is returned to the manufacturer (or the distributor) for replacement under warranty: even the manufacturer is not able to distinguish between a real product and a “real false” product.

The control system 1, that detects, stores and manages the irreproducible univocal signs associated with each individual product, provides the manufacturer with certain proof for legal purposes and makes it possible to manage the replacement of original products under warranty.

In detail, in the case of legal proceedings or a replacement request, the seventh module 8g controls requesting the consumer to produce the univocal sign associated with the product. The automatic or automatically assisted visual comparison between the received image and the image stored in the centralized database 4 will provide the certain proof for legal purposes or, in the case of product replacement under warranty, of the difference between an original product and a counterfeit product.

Control system 1, through the dedicated eighth module 8h, also controls operations related to management of the historical movements of the products.

There are certain products with low or high circulation that have substantial added value, have a duration of many years (such as works of art), are unique works, or are initially purchased by the consumer from the manufacturer and then undergo a series of ownership transfers. Advantageously, the control system 1 may provide the history of the movements occurring during the entire lifetime of the monitored products.

In particular, the following data can be associated with each product stored in the centralized database 4 (in the eighth field 5h of the data record 5 associated to the product): date of purchase or of the subsequent transfers; current owner; place of destination; this information can be inserted as a text description or as images. All information requiring the date of a single event will be stored with digital signature techniques, directly associating the date of the event in the centralized database 4.

This movement history can be updated with dedicated user interfaces by the owner, or with user interfaces and automatic modules and interfaces by third party agencies that certify the product using the control system 1. The individual product's movement history can be consulted by the owner as well as by third party agencies that certify the transfers of ownership for each product managed by the control system 1.

The eighth module 8h of the control system 1 may also control on-line creation of authenticity certificates about the product and its movements and the performed authenticity verifications.

Based on the above discussion, it is apparent that the operations performed by the second processing unit 8 of the central processing apparatus 2 for the control of the dialogue between the manufacturer and the consumer provide a number of advantageous technical effects, that will be now summarized.

The dialogue between the consumer and the manufacturer within the control system 1 is established by means of an initial request made by the consumer to verify product originality using real-time tools (PC, mobile phone, fax, etc.), that guarantee a certain and timely response. The consumer is able to send an authenticity verification request to the centralized world-wide control system 1 with all currently available methods (as well as those that will be implemented in the future), allowing to send either the sole univocal sign's digital code or the complete image of the same univocal sign. The response, on any channel, is addressed to a reference that makes it possible to securely identify the consumer having made the originality verification request. Secure protocols for encryption may be implemented both in sending and receiving the requests.

The requests are sent by the consumers to a world-wide centralized system, having one and only one reference for each means of communication (unique world-wide telephone number, unique world-wide www site, unique world-wide email address, unique postal address, etc.); this assures that systems parallel to the control system 1 are not able to send false authenticity verification results.

The authenticity verification requests are verified against unauthorized source lists (black lists) that are automatically created based on settable multiple request values that identify an unauthorized use of the control system 1. Multiple requests arriving from sources that are known a priori as agencies or inspector entities are recognized and authorized; these requests do not have an impact on the history of the requests received for the individual product.

Automatic search based on the digital code of the univocal sign and the high definition image of the same univocal sign stored in the database are performed, with a reliable search result without the use of approximation methods.

Sending to the customer of a positive authenticity verification response with particular product information (in text and/or image format), inserted by the manufacturer upon activation of the univocal sign (thereby creating the electronic irremovability of the univocal sign on the product), allows the consumer to verify that the univocal sign is applied to an original product.

The response to be sent to the consumer is based not only on the result of the processing of the received data about the univocal sign, but also on the history of the previous requests that were received for the same product (which are stored in the centralized database 4), thus allowing the implementation of suitable management strategies, which may be defined by the manufacturer for identifying counterfeits, thefts and third-party exchanges based on a cost/benefit ratio.

A stolen status may be stored in the centralized database in association with each product, for automatically identifying stolen products; analogously, the market/area/country in which the product was placed or distributed may also be stored in the centralized database, so as to allow the automatic identification of third-party exchanges.

The control system 1 also allows management of the information supplied by the consumer for the originality verification for targeted one to one marketing campaigns and for post sales assistance (e.g. for warranty activation).

The control system 1 also allows creation of a “Certain Proof” for legal purposes or for replacing a product under warranty, that may be used to distinguish between an original product and a counterfeit product.

The movement history of commercial products to which univocal signs are applied may also be managed by the control system, by monitoring of the date of purchase or transfer, of the owners and places of destination for each product. The movement history for each individual product may be queried with suitable modules and routines.

The advantages of the centralized and automated control system for checking the authenticity of a product according to the present disclosure emerge clearly from the foregoing description.

In general terms, the disclosed system allows to create a communication channel and data exchange between consumers and manufacturers, with the creation of an environment in which each consumer becomes also an inspector of the authenticity of the products, cooperating with the manufacturers in the detection of counterfeit, stolen or subject to third-party exchanges products. An alliance and an equal exchange of interests between the manufacturer and the consumer is created: the consumer is actively committed to provide product information for verifying authenticity, and the manufacturer is committed to replacing the product if it is found to be counterfeit, stolen or subjected to third-party exchange, as compensation for consumer collaboration. As additional compensation for consumer collaboration, the manufacturer may also give an award for a given number of authenticity verifications received by the control system.

In particular, the following advantageous features are provided to the manufacturer of the products to which the univocal signs are applied:
a completely automatic process for creating univocal sign lots, detection and storage of data with security techniques with the automatic assignment of a certain storage date and quality control of the univocal signs;
impossibility of creating parallel productions of univocal signs that are not actually applied to the original products;
creation of a digital code for the univocal sign, formed by a security code inserted randomly during production that makes it impossible to know the product's serial codes a priori;
activation of the univocal sign only if inserted, integrated or applied to the product in association with the particular information in the required languages, which assures the electronic irremovability of the univocal sign on the product;
verification with real time queries of all univocal signs connected to all manufacturer's products, divided by status, lot, product, etc.;
establishing of a dialogue with the consumer who uses real-time tools (such as a cell phone, internet) that makes it possible for the manufacturer to be immediately aware of products that are counterfeit, stolen, or subjected to third-party exchanges; once this dialogue is established with the consumer, it can continue with marketing, warranty activation and post-sales consumer assistance applications;
implementation of different management strategies for theft and third-party exchanges based on a cost/benefit relationship, by setting operating parameters of the control system;
obtaining of a “Certain Proof” for legal purposes or for replacement under warranty;
monitoring of the movement history for each individual product, e.g. for producing “originality certificates”.

Analogously, the following advantageous features are provided to the consumer:
certain identification of each product prevents the production of counterfeits and protects the consumer's health and safety (e.g. with regard to the purchase of a drug, a toy, an original spare part for a car, a certified food product, or a standard household appliance);
reception of an authenticity verification response for the protection of health and safety, using real-time tools (such as a cell phone, internet) that provide an immediate and secure response;
establishing of a dialogue with the manufacturer to have marketing information or post-sales assistance regarding the product;
receiving of a replacement for a product that is counterfeit, stolen or subjected to a third-party exchange;
knowledge of the movement history for a purchased product, making it possible to verify product originality.

Finally, it is clear that modifications and variations can be made to what has been described and illustrated herein, without thereby departing from the scope of the present disclosure.

In particular, the various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computerized system for verifying the authenticity of products, to each product being associated a respective univocal sign, the computerized system comprising:
a computing apparatus, configured to wirelessly receive and transmit data from/to a remote terminal; and
a centralized database operatively coupled to the computing apparatus, and including a plurality of data records, each data record being associated to a particular product and the related univocal sign and having a data structure including at least a first field for storing a description of the product and a second field for storing the related univocal sign,
wherein the computing apparatus is configured to:
receive from the remote terminal a authenticity verification request for verifying the authenticity of a given product, the request including electronic data relating to at least part of the univocal sign associated to the given product;
perform a search in the centralized database based on the received electronic data, for retrieving from the centralized database the data record associated to the given product;
perform a data comparison based on the received electronic data and the univocal sign stored in the retrieved data record;
determine a current result of the authenticity verification based on the outcome of the data comparison and also based on a preset verification strategy involving parameters relating to past authenticity verifications carried out at the computerized system for the same given product and/or parameters relating to characteristics of the given product; and
send a response to the remote terminal including the determined current result of the authenticity verification.

2. The system according to claim 1, wherein the centralized database is configured to store, in a further field of the data record associated to the given product, electronic data relating to the past authenticity verifications carried out at the computerized system for the same given product, and the past authenticity verification requests received at the computerized system for the same given product.

3. The system according to claim 2, wherein parameters relating to the past authenticity verifications for the preset verification strategy include one or more of the following: the number of past authenticity verifications stored in the further field of the data record associated to the given product; the responses sent to the consumers in response to the past authenticity verification requests; the means of communication associated to the remote terminals sending the past authenticity verification requests for checking the authenticity of the given product; and wherein the parameters relating to the characteristics of the given product for the preset verification strategy include one or more of the following: the diffusion and quantity of the given product; the intended market for the given product; the manner in which the univocal sign was inserted, integrated or applied to the given product.

4. The system according to claim 1, wherein the univocal sign includes a digital part and an image part; and wherein the computing apparatus, in the case in which the received electronic data include an electronic representation of the image part of the univocal sign, is configured to implement image processing technique for performing the data comparison for determining the current result of the authenticity verification.

5. The system according to claim 4, wherein the computing apparatus is configured to perform an image comparison and to generate a positive verification result if a comparison index associated to the image comparison is higher than a first threshold, and a negative verification result if the comparison index is lower than a second threshold.

6. The system according to claim 4, wherein the image part of the univocal sign is so generated as to be a non-reproducible analogical image univocally associated to the respective product.

7. The system according to claim 1, wherein the centralized database is further configured to store a black list for multiple unauthorized authenticity verification requests; and wherein the computing apparatus is configured, once a authenticity verification request has been received from a remote terminal, to check the black list in order to determine if parameters relating to the received authenticity verification request match with the black list, and, in case of a positive determination, is configured to block further processing of the authenticity verification request.

8. The system according to claim 1, wherein the centralized database is configured to store, in a further field of the data record associated to a product, a stolen status of the product; and wherein the computing apparatus is configured to determine the current result of the authenticity verification based also on the stolen status of the given product stored in the further field of the retrieved data record.

9. The system according to claim 1, wherein the centralized database is configured to store an intended marketing area for each product; and wherein the computing apparatus is configured to determine the current result of the authenticity verification based also on a check of a place of origin of the authenticity verification request received from the remote terminal against the intended marketing area for the given product, as retrieved from the centralized database.

10. The system according to claim 1, wherein the computing apparatus is configured to send a positive response to the remote terminal concerning the determined current result of the authenticity verification, together with the product information as retrieved from the centralized database in the first field of the data record associated to the given product.

11. The system according to claim 1, wherein said centralized database is configured to store a list of past transfers related to a product, so as to create an history of each product movements; and wherein the computing apparatus is configured to receive and handle queries about the history of movements of the given product.

12. The system according to claim 1, wherein the centralized database is configured to store, in a further field of the data record associated to a product, data concerning the manufacturer; and wherein the computing apparatus, once a authenticity verification request has been received concerning the given product, is configured to allow setting up of a communication channel between the consumer and the manufacturer of the given product for implementation of one-to-one marketing applications.

13. The system according to claim 1, wherein the computing apparatus is further configured to manage the process of generation and application of univocal signs to products, and to control storing in the centralized database, in the second field of the data record associated to each product, of the related univocal sign, after the univocal sign has been generated and applied to the same product.

14. The system according to claim 1, wherein the digital part of the univocal sign includes a serial number and a random security number; wherein the computing apparatus, at a time of generation of a new univocal sign, is configured to:
receive, from a manufacturer terminal, an electronic request for generation of a new univocal sign;
generate the serial number of the new univocal sign;
send the serial number of the new univocal sign to the manufacturer terminal;
receive, from the manufacturer terminal, the complete univocal sign generated by the manufacturer, including the whole digital part and also an image part thereof; and
store, in the second field of a new data record in the centralized database, the received univocal sign, including the digital part and the image part,
and wherein the computing apparatus, at a time of application of the univocal sign (10) to a product and activation of the univocal sign, is configured to:
receive, from the manufacturer terminal, the serial number of the univocal sign together with data related to the product to which the univocal sign has been applied by the manufacturer, including a product description;
store, in the first field of the new record in the centralized database, the product description, thus implementing an electronic irremovability of the univocal sign to the respective product within the computerized system.

15. The system according to claim 1, wherein the computing apparatus and the centralized database are implemented in a wirelessly and remotely accessible server arrangement.

16. A computer program product, comprising machine readable software instructions adapted to be executed by the computing apparatus of claim 1, for causing the computing apparatus to become configured according to claim 1.

17. A computer readable medium, for storing the computer program product according to claim 16.

18. A computer terminal at a manufacturer plant, configured to wirelessly receive and transmit data from/to a remote server storing a centralized database, the computer terminal including a processor unit being configured, at a time of generation of a new univocal sign to be associated to a manufactured product for future verification of its authenticity, to:
transmit to the remote server an electronic request for generation of the new univocal sign, the univocal sign being configured to include a digital part and an image part, and the digital part of the univocal sign being further configured to include a serial number and a random security number;
receive from the remote server, in response to the electronic request, the serial number of the new univocal sign to be generated;
generate, by means of a random number generation technique, the random security number of the digital part of the univocal sign;
generate, by means of an image formation technique, the whole univocal sign, also including the image part of the same univocal sign;
control capturing of a high-resolution image of the generated univocal sign;
transmit to the remote server electronic data associated to the captured high-resolution image, for storing in a new data record in the centralized database the digital part and the image part of the generated univocal sign.

19. The computer terminal according to claim 18, wherein the processor unit is further configured, after capturing of the high-resolution image of the generated univocal sign, to extract, by means of an image processing technique, from the captured high-resolution image, the digital part of the univocal sign and separate therefrom the image part of the same univocal sign.

20. The computer terminal according to claim 19, wherein the processor unit is further configured, after application of the generated univocal sign to a manufactured product, and for activation of the same univocal sign, to:
transmit to the remote server, the serial number of the univocal sign together with data related to the product to which the univocal sign has been applied, including a product description, for storing, in the new record in the centralized database, the same product description, thus implementing an electronic irremovability of the univocal sign to the product.

21. A computer program product, comprising machine readable program instructions adapted to be executed by the processor unit of the computer terminal of claim 18, for causing the processor unit to become configured according to claim 18.

22. A computer readable medium, for storing the computer program product according to claim 21.
